(19) United States
(12) Patent Application Publication
(10) Pub. No.: US 2011/0131247 A1
(43) Pub. Date: Jun. 2, 2011

(54) Semantic Management Of Enterprise Resourses

(75) Inventors: William A. Brown, Raleigh, NC (US); Richard W. Muirhead, Tyler, TX (US); Francis X. Reddington, Tampa, FL (US); Martin A. Wolfe, Charlotte, NC (US)

(73) Assignee: INTERNATIONAL BUSINESS MACHINES CORPORATION, Armonk, NY (US)

(21) Appl. No.: 12/627,359

(22) Filed: Nov. 30, 2009

(51) Int. Cl. G06F 17/30

(52) U.S. Cl. 707/792; 707/E17.055

(57) ABSTRACT

Semantic management of enterprise resources including identifying a plurality of disparate enterprise resources including physical resources of the enterprise and data resources of the enterprise, wherein the disparate enterprise resources are under the direction of a plurality of different management entities of the enterprise; creating for each enterprise resource a master metadata object representing the enterprise resource; wherein the structure of the each master metadata object is consistent for all the disparate enterprise resources and all management entities; wherein the master metadata object includes a plurality of predefined perspective fields, each perspective field containing a different predetermined aspects of the resources of the enterprise; assigning each master metadata object to one or more flexible reference structures; relating a plurality of master metadata objects with one or more other master metadata objects in dependence upon assigned flexible reference structures through predefined flexible reference structure fields in the master metadata objects; querying, in response to a specific user request, the related master data objects; and filtering the results of the query according to one or more enterprise views.

### BACKGROUND OF THE INVENTION

1. Field of the Invention

The field of the invention is data processing, or, more specifically, methods, apparatus, and products for semantic management of enterprise resources.

2. Description Of Related Art

Information is powerful. As the volume of information created continues to grow and as more information is shared, the potential uses of that information also increases. Traditionally the use of metadata has been drastically underestimated, underutilized, underleveraged, and due to this lack understanding, its potential has been underestimated. Metadata is commonly minimized and dismissed by being referred to as simply “data about data.” More particularly, in current enterprise systems, metadata about enterprise resources is underutilized. Metadata is especially underutilized in the management of resources across distinct management entities of an enterprise.

### SUMMARY OF THE INVENTION

Semantic management of enterprise resources including identifying a plurality of disparate enterprise resources including physical resources of the enterprise and data resources of the enterprise, wherein the disparate enterprise resources are under the direction of a plurality of different management entities of the enterprise; creating for each enterprise resource a master metadata object representing the enterprise resource; wherein the structure of the each master metadata object is consistent for all the disparate enterprise resources and all management entities; wherein the master metadata object includes a plurality of predefined perspective fields, each perspective field containing a different predetermined aspects of the resources of the enterprise; assigning each master metadata object to one or more flexible reference structures; relating a plurality of master metadata objects with one or more other master metadata objects in dependence upon assigned flexible reference structures through predefined flexible reference structure fields in the master metadata objects; querying, in response to a specific user request, the related master data objects; and filtering the results of the query according to one or more enterprise views.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a diagram of a system for semantic management of enterprise resources according to embodiments of the present invention.

FIG. 2 sets forth a block diagram of automated computing machinery comprising an exemplary computer useful in semantic management of enterprise resources according to embodiments of the present invention.

FIG. 3 sets forth a block diagram illustrating the structure of an example master metadata object according to embodiments of the present invention.

FIG. 4 sets forth a flow chart illustrating a further exemplary method semantic management of enterprise resources according to embodiments of the present invention.

### DETAILED DESCRIPTION OF EXEMPLARY EMBODIMENTS

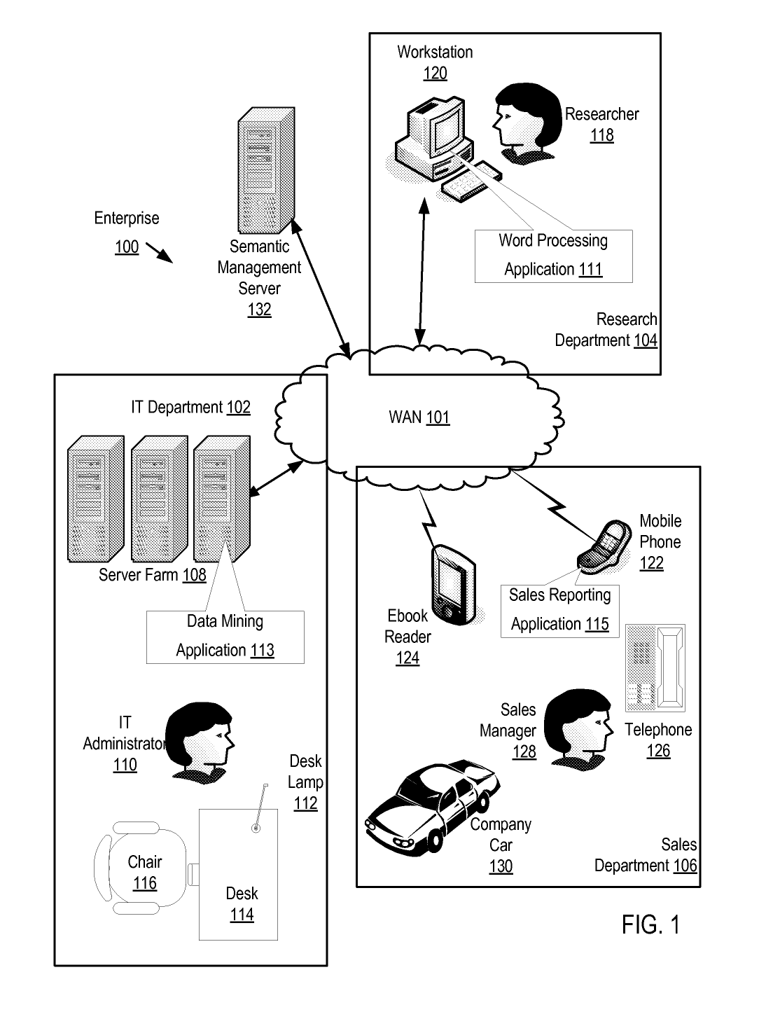

Exemplary methods, apparatus, and products for semantic management of enterprise resources in accordance with the present invention are described with reference to the accompanying drawings, beginning with FIG. 1. FIG. 1 sets forth a system diagram of a system for semantic management of enterprise resources according to embodiments of the present invention. The example of FIG. 1 includes an exemplary enterprise (100). An example of an enterprise capable of managing its resource through semantic management according to embodiments of the present invention is a business enterprise, but other enterprises such as government agencies, military operations, and others as will occur to those of skill in the art are within the scope of the present invention.

The exemplary enterprise (100) of FIG. 1 includes three management entities, an IT department (102), a research department (104), and a sales department. Each of the three management entities (102, 104, and 106) direct different enterprise resources of the enterprise (100). The enterprise resources of the enterprise under the direction of the management entities are both physical resources and data resources. Such enterprise resources may include employees of the enterprise, customers of the enterprise, procedures the enterprise, equipment of the enterprise, data of the enterprise, computational processes of the enterprise, and many others as will occur to those of skill in the art.

The IT department (102) in the example of FIG. 1 has under its direction a number of enterprise resources, a server farm (108) coupled for data communications with a wide area network (‘WAN’), a data mining application (113) installed and executing on a server of the server farm, an IT administrator (110), a desk (114), a chair (116), and a desk lamp (112). The research department (104) of FIG. 1 has under its direction a number of enterprise resources, a workstation (120) coupled for data communications with the WAN (101), a word processing application (111) installed an executing on the workstation, and a researcher (118). The sales department of FIG. 1 has under its direction a number of enterprise resources, an Ebook reader (124), a mobile phone (122), a sales reporting application (115) installed and executing on the mobile phone, a telephone (126), a company car (130), and a sales manager.

The exemplary enterprise (100) of FIG. 1 also includes a semantic management server (132) capable of semantic management of enterprise resources according to embodiments of the present invention. The semantic management server (132) of FIG. 1 is capable of identifying a plurality of disparate enterprise resources (108, 110, 111, 112, 113, 114, 115, 116, 120, 118, 122, 124, 126, 128, and 130) including physical resources of the enterprise (108, 110, 112, 114, 116, 120, 118, 122, 124, 126, 128, and 130) and data resources of the enterprise (111, 113, 115). As mentioned above, the disparate enterprise resources are under the direction of a plurality of different management entities (102, 104, and 106) of the enterprise (100).

The semantic management server (132) of FIG. 1 is capable of creating for each enterprise resource (108, 110, 111, 112, 113, 114, 115, 116, 120, 118, 122, 124, 126, 128, and 130) a master metadata object representing the enterprise resource. The structure of the each master metadata object is consistent for all the disparate enterprise resources and all management entities. Having a consistent structure for the master metadata object of both physical resources of the enterprise and data resources of the enterprise regardless of management entity allows for increased awareness, through semantic management according to the present invention, of the enterprise across management entities and across relationships among resources.

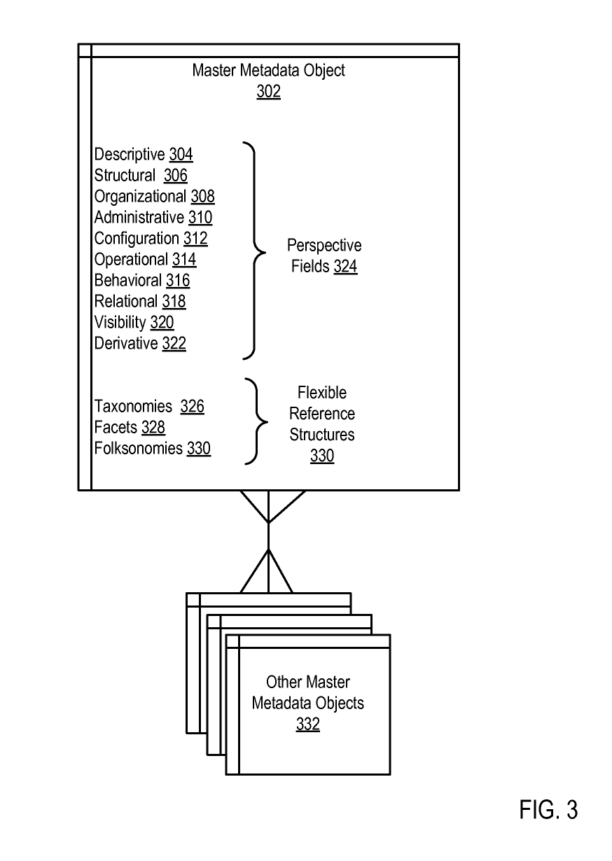

The master metadata objects of the present invention include a plurality of predefined perspective fields. A perspective field contains a predetermined aspect of a resource of the enterprise. Such a perspective field typically includes data describing how the resource is used, data describing what the resource is, data describing why the resource is used, data describing who uses the resource, or data describing where and when the resource is used. As described below with reference to FIG. 3, examples of such perspective fields include fields containing data about the enterprise resource that is descriptive, structural, organizational, administrative, configurational, operational, behavioral, relational, defining visibility, derivational, and others as will occur to those of skill in the art.

The semantic management server (132) of FIG. 1 is capable of assigning each master metadata object to one or more flexible reference structures. A flexible reference structure defines a context of the resource represented by the master metadata object. Such a context often includes predefined relationship types among the disparate enterprise resources or predefined attributes of one or more of the disparate enterprise resources. Typically such contexts are organizational, relational, linguistic, definitional, or even arbitrary based upon user selected contexts. Despite a wide range of possible contexts for an enterprise resource, the flexible reference structure defines contexts that are predetermined to be useful to a user of the enterprise in relating the master metadata objects for the resources of the enterprise. As described below with reference to FIG. 3, examples of flexible reference structures include taxonomies, including homographs, heterographs, capitonyms, hypernyms, hyponyms, meronyms, polysemes; facets; and folksonomies.

The semantic management server (132) of FIG. 1 is capable of relating a plurality of master metadata objects with one or more other master metadata objects in dependence upon assigned flexible reference structures through predefined flexible reference structure fields in the master metadata objects. Relating master metadata objects through a wide range of possible flexible reference structure fields provides a framework that is much more robust than conventional relational models. Such conventional relational models are typically unable to distinguish various relations such as particular associations and particular inheritances of objects and therefore are extremely limited in their ability to provide relevant semantics to enterprise resources. The related master metadata objects may now be queried and the results of such queries are semantic in ways currently unavailable in other conventional enterprise management systems.

The semantic management server (132) of FIG. 1 is capable of querying, in response to a specific user request, the related master data objects. The semantic management server (132) is capable of developing a query, such as am Structured Query Language (‘SQL’) query from a natural language request from a user and querying a relational database of master metadata objects using the developed query.

The semantic management server (132) of FIG. 1 is capable of filtering the results of the query according to one or more enterprise views. An enterprise view is a predefined rule set for filtering the raw semantic results of querying the related master metadata objects designed for a particular enterprise function. Such a rule set may define master metadata objects to be omitted from the results based upon the enterprise function. For example, enterprise view for an enterprise function of ‘software security management’ may filter master metadata objects unrelated to software security such as master metadata objects for physical desks and chairs of the enterprise. In contrast, however, an enterprise view for the more general enterprise function of ‘security’ may not filter master metadata objects of physical chairs and desks and they are physical resources that are to be secured.

The semantic management server (132) of FIG. 1 is capable of creating a management model in dependence upon the filtered results of the query. Such a management model may include visual depictions of the relations of the enterprise resources represented by master metadata objects remaining after filtering the query results, description of those resources, and other information depending on the specific nature of the management model to be created. Examples of management models capable of being created according to embodiments of the present invention include models for Domain Management, Domain Modeling, Domain Analysis, Domain Verification, Service Discovery, Service Identification, Service Integration, Intelligent Routing, Canonical Messaging Modeling, Transformation, Governance Traceability, Strategic Assessment, Compliance Auditing, Security Auditing, Process and Information Validation, Capability Discovery, Schema Creation and Validation, Searching and Data Retrieval, Real Time Analytics, Information Assets, Multi-Dimension Viewpoint Reporting, Real-Time Decision Making, Process Optimization, Composite Data Integration, Data Reuse and Sharing, Enforcement Of Master Data Management, Object Creation, Resource and Capacity Management, Transaction Monitoring, Business Monitoring, System Monitoring, Performance Monitoring, Proactive Alerting, Capacity Planning, Metering, Billing, Event Management, Rapid Architectural and Application Design and others as will occur to those of skill in the art.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

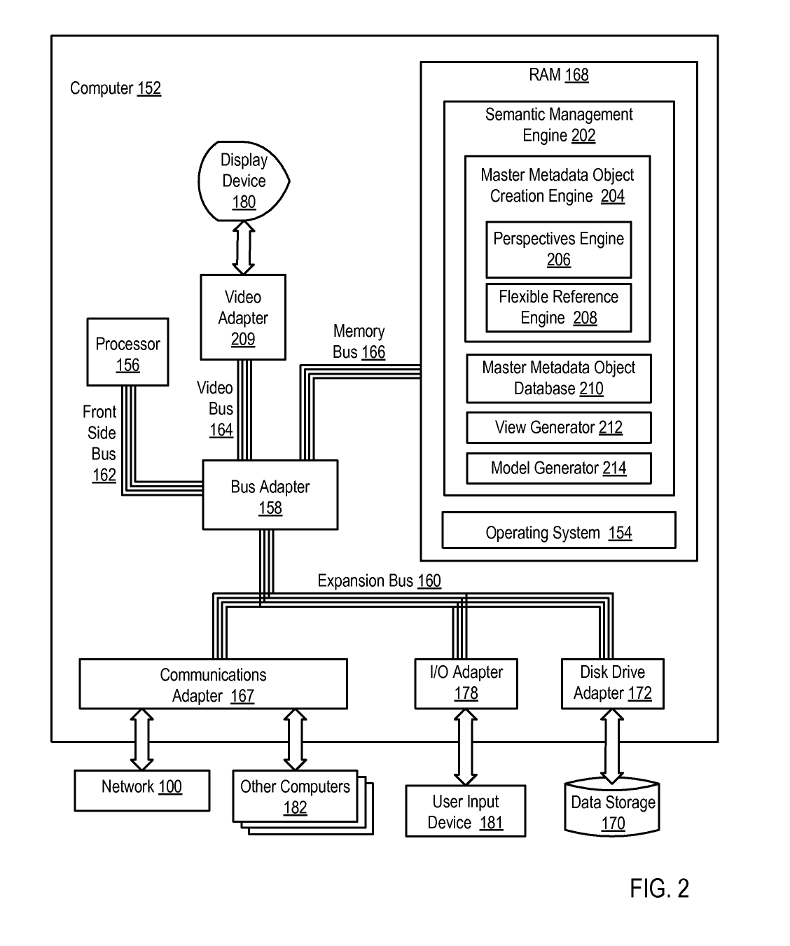

Semantic management of enterprise resources in accordance with the present invention is generally implemented with computers, that is, with automated computing machinery. For further explanation, therefore, FIG. 2 sets forth a block diagram of automated computing machinery comprising an exemplary computer (152) useful in semantic management of enterprise resources according to embodiments of the present invention. The computer (152) of FIG. 2 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is a semantic management engine (202), a module of computer program instructions for semantic management of enterprise resources according to embodiments of the present invention. The semantic management engine (202) includes a master metadata object creation engine (204) capable of identifying a plurality of disparate enterprise resources including physical resources of the enterprise and data resources of the enterprise, wherein the disparate enterprise resources are under the direction of a plurality of different management entities of the enterprise; creating for each enterprise resource a master metadata object representing the enterprise resource. The structure of the each master metadata object is consistent for all the disparate enterprise resources and all management entities.

The master metadata object creation engine (204) of FIG. 2 includes a perspectives engine (206), a module of computer program instructions capable of populating a plurality of predefined perspective fields of the master metadata objects. Each perspective field contains one or more different predetermined aspects of the resources of the enterprise,

The master metadata object creation engine (204) of FIG. 2 also includes a flexible reference engine (208), a module of computer program instructions capable of assigning each master metadata object to one or more flexible reference structures and relating a plurality of master metadata objects with one or more other master metadata objects in dependence upon assigned flexible reference structures through predefined flexible reference structure fields in the master metadata objects.

The semantic management engine (202) includes a master metadata object database (210) containing the related master metadata objects. The master metadata object data base is capable of receiving queries in response to user requests and returning results with increased semantic value in dependence upon the perspectives and flexible reference structures of the master metadata objects.

The semantic management engine (202) includes a view generator (212) capable of filtering the results of the query according to one or more enterprise views. The semantic management engine (202) also includes a model generator (214) capable of creating a management model in dependence upon the filtered results of the query.

Also stored in RAM (168) is an operating system (154). Operating systems useful [preamble] according to embodiments of the present invention include UNIX™, Linux™, Microsoft XP™, AIX™, IBM's i5/OS™, and others as will occur to those of skill in the art. The operating system (154) and semantic management engine (202) in the example of FIG. 2 are shown in RAM (168), but many components of such software typically are stored in non-volatile memory also, such as, for example, on a disk drive (170).

The computer (152) of FIG. 2 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for semantic management of enterprise resources according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 2 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 2 includes a communications adapter (167) for data communications with other computers (182) and for data communications with a data communications network (100). Such data communications may be carried out serially through RS-232 connections, through external buses such as a Universal Serial Bus (USW), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for semantic management of enterprise resources according to embodiments of the present invention include modems for wired dial-up communications, Ethernet (IEEE 802.3) adapters for wired data communications network communications, and 802.11 adapters for wireless data communications network communications.

For further explanation, FIG. 3 sets forth a block diagram illustrating the structure of an example master metadata object (302) according to embodiments of the present invention. The example master metadata object (302) of FIG. 3 includes a set of perspective fields (324) and a set of flexible reference structure fields (300) that are consistent for all master metadata objects representing enterprise resources in the enterprise.

The example master metadata object (302) includes a set of perspective fields (324). As mentioned above, a perspective field (324) contains a predetermined aspect of the resources of the enterprise. Such a perspective field typically includes data describing how the resource is used, data describing what the resource is, data describing why the resource is used, data describing who uses the resource, or data describing where and when the resource is used. Each of the perspective fields of FIG. 3 typically include either data describing that predetermined aspect of the resource or a pointer to a perspective object containing data describing that predetermined aspect of the resource.

The master metadata object (302) of FIG. 3 includes an example perspective field (324) labeled descriptive (304). The descriptive field includes information describing the enterprise resource represented by the master metadata object just as the name of the resource, any aliases of the resources, the subject matter of the resource the size of the resource, the materials the resource is made of, the physical location of the resource and so on as will occur to those of skill in the art.

The master metadata object (302) of FIG. 3 includes an example perspective field (324) labeled structural (306). The structural field includes information describing the business and data entities of the enterprise resource such as a blue print of the enterprise resource, the class of the enterprise resource, data type of the enterprise resource, schema definitions for the resource and so on as will occur to those of skill in the art.

The master metadata object (302) of FIG. 3 includes an example perspective field (324) labeled organizational (308). The organizational field includes information describing the dependencies, inter-relationships, and groupings of the enterprise resource with respect to other resources. For example, in order for a resource of a particular column in a table to exist, it must be part of a table and there must be table and typically the table is a subset of a database.

The master metadata object (302) of FIG. 3 includes an example perspective field (324) labeled administrative (310). The administrative field includes information describing the management of the enterprise resource such as individual or group ownership of the resource, management entity of the resource, status of the resource such as manager, contractor, and so on as will occur to those of skill in the art.

The master metadata object (302) of FIG. 3 includes an example perspective field (324) labeled configuration (312). The configuration field includes information describing the definitions of the resource, settings of the resource, logistics of the resource and so on as will occur to those of skill in the art.

The master metadata object (302) of FIG. 3 includes an example perspective field (324) labeled operational (314). The operational field includes information describing auditing and monitoring associated with the resource, services and processes associated with the resource, metrics used to evaluate the resource and so on as will occur to those of skill in the art.

The master metadata object (302) of FIG. 3 includes an example perspective field (324) labeled behavioral (316). The behavioral field includes information describing the intended use of the enterprise resource, functions of the resource, and so on as will occur to those of skill in the art.

The master metadata object (302) of FIG. 3 includes an example perspective field (324) labeled relational (318). The relational field includes information describing one or more relationships between the resource and another resource such as that this resource has n association with another resource, is a child of another resource, and so on as will occur to those of skill in the art.

The master metadata object (302) of FIG. 3 includes an example perspective field (324) labeled visibility (320). The visibility field includes information describing who has access to the resource such as is the resource private to an individual or specialized group, public across the enterprise and so on as will occur to those of skill in the art.

The master metadata object (302) of FIG. 3 includes an example perspective field (324) labeled derivative (322). The derivative field includes information describing knowledge that can be derived from the enterprise resource.

The master metadata object (302) of FIG. 3 includes a set of flexible reference structures (330). As mentioned above, a flexible reference structure defines a context of the resource represented by the master metadata object. Such a context often includes predefined relationship types among the disparate enterprise resources or predefined attributes of one or more of the disparate enterprise resources. Typically such contexts are organizational, relational, linguistic, definitional, or even arbitrary based upon user selected contexts. Despite a wide range of possible contexts for an enterprise resource, the flexible reference structure defines contexts that are predetermined to be useful to a user of the enterprise in relating the master metadata objects for the resources of the enterprise. The master metadata object (302) of FIG. 3 is related in a many-to-many relationship with other master metadata objects (332) through one or more of the flexible reference structure fields (330) used as foreign keys.

The master metadata object (302) of FIG. 3 includes an example flexible reference structure field labeled taxonomies (326). A taxonomy is a controlled vocabulary that establishes a relationship with another object such as a parent-child-sibling relationship, peer-to-peer relationship, or other relationship defined through a controlled vocabulary.
A Homograph is an example of a taxonomy that defines words describing enterprise resources that sound the same and have same spelling but differ in origin or meaning, such as for example, the ‘bow’ of ship and a stage ‘bow’, ‘desert’ (abandon) and ‘desert(arid region) and others as will occur to those of skill in the art. Homographs are a type of Homonym
A Heterophone, also referred to as heteronym, is an example of a taxonomy that defines words describing enterprise resources with the same spelling but different meaning and that are pronounced differently such as moped (depressed attitude) and moped (motorized scooter). Heterophones are a type of Homonyms
A Capitonym is an example of a taxonomy that defines the words describing enterprise resources that have one meaning when capitalized such as ‘Polish’ (ethnicity) and another meaning when not capitalized such as ‘polish’ (shine).
A Hypernym is an example of a taxonomy that defines words describing enterprise resources such as the generalized direction from bottom up from subclass to superclass such as a duck is hypernym of bird.
A Hyponym is an example of a taxonomy that defines words describing enterprise resources such as generalized direction from top down from superclass to subclass such as vehicle is hyponym of car.
A Meronym is an example of a taxonomy that describes enterprise resources that are part of a whole such as beak is a meronym of bird.
A Polyseme is an example of a taxonomy that describes enterprise resources that have words describing them with more than one meaning such as chair (furniture) and chair (position on a review board).

The master metadata object (302) of FIG. 3 includes an example flexible reference structure field labeled facets (328). A facet is a grouping of enterprise resources organized by characteristics and attributes of those resources. For example, a department store has a clothing department that sorts clothes by size, color, style, and so on.

The master metadata object (302) of FIG. 3 includes an example flexible reference structure field labeled folksonomies (330). A folksonomy is a user formed organic aggregated groupings around an enterprise resource. Such folksonomies are typically formed by users through social tagging of resources, annotating the metadata objects with arbitrarily defined descriptive metadata, arbitrary user defined groupings of resources and so on as will occur to those of skill in the art.

The exemplary fields of the perspective fields (324) and the flexible reference structure fields (330) of the master metadata object (302) of FIG. 3 are for explanation and not for limitation. In fact, master metadata objects according to embodiments of the present invention may include additional and different perspective fields and flexible reference structure fields as will occur to those of skill in the art.

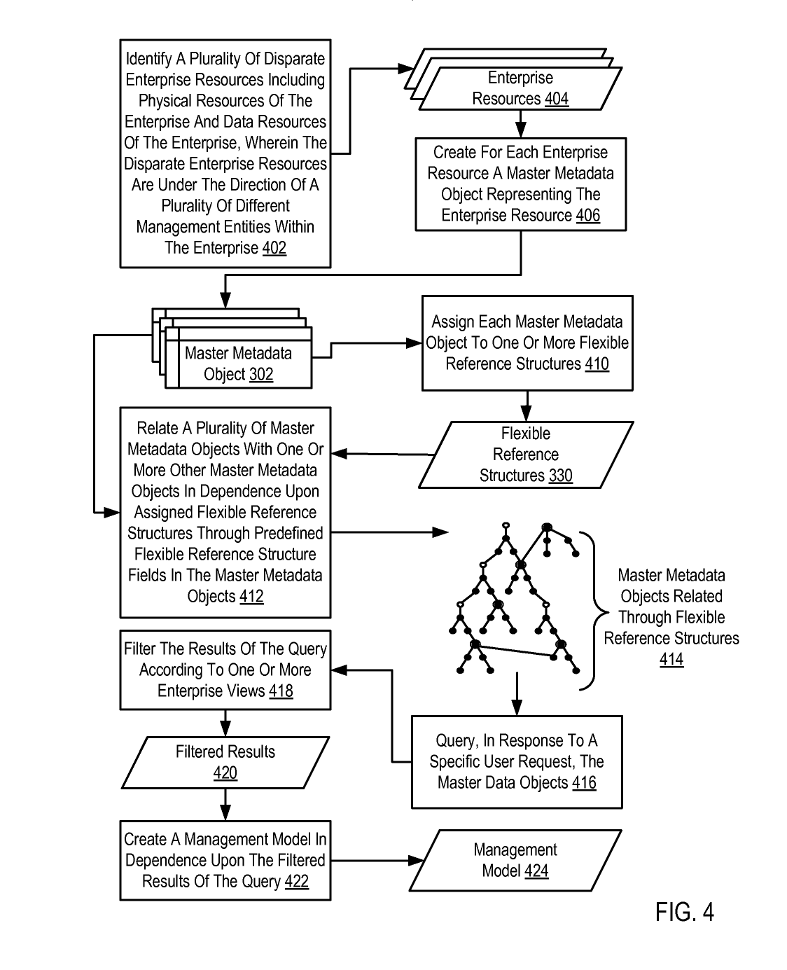

For further explanation, FIG. 4 sets forth a flow chart illustrating a further exemplary method semantic management of enterprise resources according to embodiments of the present invention. The method of FIG. 4 includes identifying (402) a plurality of disparate enterprise resources (404). Identifying (402) a plurality of disparate enterprise resources (404) may be carried out by traversing a list of physical and data assets of the entity such as employee lists, process lists, physical inventory, software installed in the entity and so on and selecting one-by-one each enterprise resource to be represented by a master metadata object.

As mentioned above, the disparate enterprise resources of FIG. 4 include both physical resources of the enterprise and data resources of the enterprise. The disparate enterprise resources (404) of FIG. 4 are also are under the direction of a plurality of different management entities of the enterprise. Examples of such enterprise resources according to the method of FIG. 4 include one or more employees of the enterprise, one or more pieces of equipment of the enterprise, data of the enterprise, and one or more computational processes of the enterprise, and may others as will occur to those of skill in the art.

The method of FIG. 4 also includes creating (406) for each enterprise resource (404) a master metadata object (302) representing the enterprise resource (404). Creating (406) for each enterprise resource (404) a master metadata object (302) representing the enterprise resource (404) may be carried out by instantiating an object of a predefined structure for the enterprise resource.

As mentioned above, the structure of the each master metadata object (302) is consistent for all the disparate enterprise resources and all management entities. The master metadata object of FIG. 4 includes a plurality of predefined perspective fields, each perspective field containing a different predetermined aspects of the resources of the enterprise. As mentioned above, the one or more of the plurality of predefined perspective fields of the master metadata objects (302) of FIG. 4 include data describing how the resource is used, data describing what the resource is, data describing why the resource is used, data describing who uses the resource, where and when the resource is used and other perspectives as will occur to those of skill in the art.

The method of FIG. 4 also includes assigning (410) each master metadata object (302) to one or more flexible reference structures (330). As mentioned above, a flexible reference structure defines a context of the resource represented by the master metadata object. Such a context often includes predefined relationship types among the disparate enterprise resources or predefined attributes of one or more of the disparate enterprise resources. Typically such contexts are organizational, relational, linguistic, definitional, or even arbitrary based upon user selected contexts.

In some embodiments of the present invention, the flexible reference structures (300) include taxonomies, facets, folksonomies.

The method of FIG. 4 also includes relating (412) a plurality of master metadata objects (302) with one or more other master metadata objects (302) in dependence upon assigned flexible reference structures (330) through predefined flexible reference structure fields in the master metadata objects (302). Relating (412) a plurality of master metadata objects (302) with one or more other master metadata objects (302) in dependence upon assigned flexible reference structures (330) through predefined flexible reference structure fields in the master metadata objects (302) may be carried out by relating the master metadata object many-to-many to other master metadata objects through one or more flexible reference structure fields used as a foreign key.

The method of FIG. 4 includes querying (416), in response to a specific user request, the related master data objects (414). Querying (416), in response to a specific user request, the related master data objects (414) may be carried out by developing a query, such as am Structured Query Language (‘SQL’) query from a natural language request from a user and querying a relational database of master metadata objects using the developed query.

The method of FIG. 4 includes filtering (420) the results of the query according to one or more enterprise views. Filtering (420) the results of the query according to one or more enterprise views may be carried out by omitting one or more objects of the results of the query. As mentioned above, an enterprise view is a predefined rule set for filtering the raw semantic results of querying the related master metadata objects designed for a particular enterprise function. Such a rule set may define master metadata objects to be omitted from the results based upon the enterprise function. For example, enterprise view for an enterprise function of ‘software security management’ may filter master metadata objects unrelated to software security such as master metadata objects for physical desks and chairs of the enterprise. In contrast, however, an enterprise view for the more general enterprise function of ‘security’ may not filter master metadata objects of physical chairs and desks and they are physical resources that are to be secured.

The method of FIG. 4 includes creating a management model in dependence upon the filtered results of the query. Creating a management model in dependence upon the filtered results of the query may include creating graphs and charts illustrating the filtered query results, descriptions of the filtered query results and so on as will occur to those of skill in the art. Such a management model may include visual depictions of the relations of the enterprise resources represented by master metadata objects remaining after filtering the query results, description of those resources, and other information depending on the specific nature of the management model to be created.

Examples of management models capable of being created according to embodiments of the present invention include to name only a few:
Domain Management—Metadata characteristics about objects that are part of a specific domain can be retrieved and that information enables intelligent domain management models for those objects.
Domain Modeling—Metadata characteristics about objects can be retrieved and that information enables the application means to model that content into characterized groups by a specific feature, ownership or functional groups
Domain Analysis—Metadata characteristics about objects can be retrieved and that information enables the application means to organize that content into characterized groups by a specific feature, ownership or functional groups thus enabling organization though the domain modeling process.
Domain Verification—Metadata characteristics about objects can be retrieved and that information enables the application means to model what characterized groups the content is classified under.
Service Discovery—Metadata characteristics about objects can be retrieved and that information enables modeling of what a service are available , and what they would provide.
Service Identification—Metadata characteristics about objects can be retrieved and that information enables modeling verification that a service exist.
Service Integration—Metadata characteristics about objects can be retrieved and that information enables an application to model not only how to integrate to services but more importantly what services it make sense to integrate to or combine integration between.
Intelligent Routing—Metadata characteristics about objects can be retrieved and that information enables modeling dispatching software to intelligently direct request to the correct delivery channels.
Canonical Messaging Model—Metadata characteristics about objects can be retrieved and that information enables modeling the use of this specific representative metadata as an standardized integration exchange media
Transformation—Metadata characteristics about objects can be retrieved and that information enables modeling the identification and then matching various transformation templates that need to be applied to the original content, depending upon the associated subscribe delivery channels
Governance—Metadata characteristics about objects can be retrieved and that information enables an application to model and identify object methods which can then be associated to procedures managed within governance policies.
Strategic Assessment—Modeling a direct correlation of what essential metadata characteristics about object are key indicators of fulfilling strategic objectives.
Compliance Audit—Maintaining a history of metadata characteristics about objects that are retrieved enables an application to model and verify if an object methods are executed within compliance guidelines
Security and Audit—A security audit travel can trace what metadata characteristics about objects that are retrieved by whom, when, and what was the context of their inquiry.
Validation—Metadata characteristics about objects can be retrieved and that information enables an application to validate aspects of it expected correctness, completeness or expected values.
Schemas—Metadata characteristics about objects related hierarchical and structural perspectives view, can be used to validate or dynamically create schema definitions.
Searching and Retrieval—Metadata characteristics about objects and their associated object characteristics can be retrieved and searched.
Analytics—Analysis of object metadata characteristics and their associated relationship to other object provide the basis of usage, behavioral, transactional, and marketing analytics.
Information Assets—Metadata characteristics about objects provide a robust profile of an information asset.
Multi-Dimension Viewpoints—Multiple Dimension viewpoints of an objects metadata characteristics enables application to model this objects metadata in multiple and distinctive ways.
Reporting—Metadata characteristics about objects and their related objects provide a comprehensive source of reporting of enterprise wide information.
Real-Time Decisions—Metadata characteristics such as status or state or specific indicator value can be leverage to drive real-time decisions
Process Optimization—Metadata characteristics about objects such as processes, and the execution timing of theses processes can provide the basis for process refactoring and optimization analysis.
Composite Data Integration—Metadata characteristics about objects and their related objects can be composed and aggregated into larger information assets.
Data Reuse and Sharing—Metadata characteristics about objects and their related objects provide an inventory that can be analyzed for redundancies.
Master Data Management—Metadata characteristics about objects and similar defined objects provide an inventory that can be reduced and standardize to a single reference
Object Creation—Metadata characteristics about objects and or related objects structural definitions can be used to dynamically create new objects.
Resource & Capacity Management—Metadata characteristics about objects use of system resources can provide the basis of baseline resource utilization and forecasting capacity planning
Establish Semantic Relationships—Analysis of an objects metadata characteristics can provide a basis of determining whether there is a direct relevant metadata characteristics of another object that would justify the creation of a semantic relationship.
Monitoring—Analysis of an objects metadata characteristics can provide a basis of monitoring that object for changes, or how it used in conjunction with other objects.
Business Monitoring—Analysis of an objects metadata characteristics can provide a basis of monitoring that object for changes, or how it used in conjunction with other objects in the context of business model processing.
System Monitoring—Analysis of an objects metadata characteristics can provide a basis of monitoring that object for changes, or how it used in conjunction with other objects in the context of system related processing.
Performance Monitoring—Analysis of an objects metadata characteristics can provide a basis of monitoring that object for changes, or how it used in conjunction with other objects in the context of how efficient it utilizes system resources.
Proactive Alerting—Analysis of an objects metadata characteristics can provide a basis of proactive monitoring that object for changes, in acceptable threshold values before a proactive alert is sent as a warning indication.
Metering—Analysis of an objects metadata characteristics can provide a basis of monitoring that object usage for the purpose of charging for that usage.
Billing—Analysis of an objects metadata characteristics can provide a basis of monitoring that object for changes, or how long it is used then applied to a determined rate structure for billing for that usage.
Event Management—Metadata characteristics about triggering conditions and response corresponding to objects use can be readily used to create the foundation of an event management system.

Exemplary embodiments of the present invention are described largely in the context of a fully functional computer system for semantic management of enterprise resources semantic management of enterprise resources. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flow charts and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the present application illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of semantic management of enterprise resources, the method comprising:
identifying a plurality of disparate enterprise resources including physical resources of the enterprise and data resources of the enterprise, wherein the disparate enterprise resources are under the direction of a plurality of different management entities of the enterprise;
creating for each enterprise resource a master metadata object representing the enterprise resource;
wherein the structure of the each master metadata object is consistent for all the disparate enterprise resources and all management entities;
wherein the master metadata object includes a plurality of predefined perspective fields, each perspective field containing a different predetermined aspects of the resources of the enterprise;
assigning each master metadata object to one or more flexible reference structures;
relating a plurality of master metadata objects with one or more other master metadata objects in dependence upon assigned flexible reference structures through predefined flexible reference structure fields in the master metadata objects;
querying, in response to a specific user request, the related master data objects; and
filtering the results of the query according to one or more enterprise views.

2. The method of claim 1 further comprising creating a management model in dependence upon the filtered results of the query.

3. The method of claim 1 wherein the enterprise resources include one or more employees of the enterprise, one or more pieces of equipment of the enterprise, data of the enterprise, and one or more computational processes of the enterprise.

4. The method of claim 1 wherein the one or more of the plurality of predefined perspective fields includes data describing how the resource is used, data describing what the resource is, data describing why the resource is used, data describing who uses the resource, and data describing where and when the resource is used.

5. The method of claim 1 wherein the one or more flexible reference structures includes taxonomies.

6. The method of claim 1 wherein the one or more flexible reference structures includes facets.

7. The method of claim 1 wherein the one or more flexible reference structures includes folksonomies.

8. Apparatus for semantic management of enterprise resources, the apparatus comprising a computer processor, a computer memory operatively coupled to the computer processor, the computer memory having disposed within it computer program instructions capable of:
identifying a plurality of disparate enterprise resources including physical resources of the enterprise and data resources of the enterprise, wherein the disparate enterprise resources are under the direction of a plurality of different management entities of the enterprise;
creating for each enterprise resource a master metadata object representing the enterprise resource;
wherein the structure of the each master metadata object is consistent for all the disparate enterprise resources and all management entities;
wherein the master metadata object includes a plurality of predefined perspective fields, each perspective field containing a different predetermined aspects of the resources of the enterprise;
assigning each master metadata object to one or more flexible reference structures;
relating a plurality of master metadata objects with one or more other master metadata objects in dependence upon assigned flexible reference structures through predefined flexible reference structure fields in the master metadata objects;
querying, in response to a specific user request, the related master data objects; and
filtering the results of the query according to one or more enterprise views.

9. The apparatus of claim 1 wherein the computer memory also has disposed within it computer program instructions capable of creating a management model in dependence upon the filtered results of the query.

10. The apparatus of claim 1 wherein the enterprise resources include one or more employees of the enterprise, one or more pieces of equipment of the enterprise, data of the enterprise, and one or more computational processes of the enterprise.

11. The apparatus of claim 1 wherein the one or more of the plurality of predefined perspective fields includes data describing how the resource is used, data describing what the resource is, data describing why the resource is used, data describing who uses the resource, and data describing where and when the resource is used.

12. The apparatus of claim 1 wherein the one or more flexible reference structures includes taxonomies.

13. The apparatus of claim 1 wherein the one or more flexible reference structures includes facets.

14. The apparatus of claim 1 wherein the one or more flexible reference structures includes folksonomies.

15. A computer program product for semantic management of enterprise resources, the computer program product disposed upon a computer readable storage medium, the computer program product comprising computer program instructions capable, when executed, of causing a computer to carry out the steps of:
identifying a plurality of disparate enterprise resources including physical resources of the enterprise and data resources of the enterprise, wherein the disparate enterprise resources are under the direction of a plurality of different management entities of the enterprise;
creating for each enterprise resource a master metadata object representing the enterprise resource;
wherein the structure of the each master metadata object is consistent for all the disparate enterprise resources and all management entities;
wherein the master metadata object includes a plurality of predefined perspective fields, each perspective field containing a different predetermined aspects of the resources of the enterprise;
assigning each master metadata object to one or more flexible reference structures;
relating a plurality of master metadata objects with one or more other master metadata objects in dependence upon assigned flexible reference structures through predefined flexible reference structure fields in the master metadata objects;
querying, in response to a specific user request, the related master data objects; and
filtering the results of the query according to one or more enterprise views.

16. The computer program product of claim 1 further comprising computer program instructions capable of creating a management model in dependence upon the filtered results of the query.

17. The computer program product of claim 1 wherein the enterprise resources include one or more employees of the enterprise, one or more pieces of equipment of the enterprise, data of the enterprise, and one or more computational processes of the enterprise.

18. The computer program product of claim 1 wherein the one or more of the plurality of predefined perspective fields includes data describing how the resource is used, data describing what the resource is, data describing why the resource is used, data describing who uses the resource, and data describing where and when the resource is used.

19. The computer program product of claim 1 wherein the one or more flexible reference structures includes taxonomies.

20. The computer program product of claim 1 wherein the one or more flexible reference structures includes facets.

21. The computer program product of claim 1 wherein the one or more flexible reference structures includes folksonomies.
